(19) United States
(12) Patent Application Publication
(10) Pub. No.: US 2008/0189539 A1
(43) Pub. Date: Aug. 7, 2008

(54) COMPUTER SYSTEM FOR AUTHENTICATING REQUESTED SOFTWARE APPLICATION THROUGH OPERATING SYSTEM AND METHOD THEREOF

(76) Inventor: Ming-Tso Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/670,425

(22) Filed: Feb. 2, 2007

(51) Int. Cl. G06F 15/177

(52) U.S. Cl. 713/2

(57) ABSTRACT

The present invention discloses a computer system. The computer system includes a storage device and a processor. The storage device stores a loader authenticator, a boot loader, an operating system, and at least a software application. The processor is coupled to the storage device for executing the loader authenticator to authenticate the boot loader. When the boot loader passes the authentication, the boot loader is executed to authenticate at least the operating system, wherein the at least one software application is not authenticated by the boot loader.

### BACKGROUND OF THE INVENTION

1. Field of the Invention

The present invention is related to a computer system and an operating method thereof, and more particularly, to a computer system capable of authenticating requested software applications through an operating system and a method thereof.

2. Description of the Prior Art

The digitization of multimedia content has resulted in the demand for content protection technology in order to prevent any illegal copy or piracy of the premium contents. Well-known content protection technology includes Conditional Access (CA), and Digital Right Management (DRM). Other protection mechanisms and/or software components are also introduced to prevent piracy. Usually this involves the descrambling and decryption of the protected content when the user is authorized to access premium content. Secure boot is common knowledge in the content protection field. Furthermore, secure boot technology was invented to prevent the above mentioned protection mechanism from being hacked into or tampered with. The secure boot technology is a sort of software execution chain protection, operative from the system power on to the operation stage, and all related software components are well protected by ensuring their authenticity. Normally, a digital signature or a similar technology is used to verify the authenticity of the software applications stored within the permanent storage device, from which the system, upon powering on, will execute those software applications stored therein.

Please refer to FIG. 1, which is a flowchart illustrating a conventional method of secure boot performed upon a computer system. The method comprises the following steps:

Step 101: Power on the computer system;

Step 102: Activate a secure boot loader authenticator to authenticate a secure boot loader;

Step 103: Activate the secure boot loader to authenticate a main image of the computer system; and

Step 104: Execute the main image of the computer system.

In step 102, the secure boot loader authenticator is, for example, stored within a read-only permanent storage region of the computer system (e.g. stored in a OTP (One Time Programming) region of a non-volatile memory) to achieve better security. In other examples, the storage containing the secure boot loader authenticator is embedded inside the CPU (Central Processing Unit) chip. In other examples, an obfuscation mechanism is introduced such that the authentication algorithm is not external accessible when the storage containing the secure boot loader authenticator can not be embedded inside the CPU chip. Furthermore, the secure boot loader authenticator is the first code to run at the boot time. After the secure boot loader is authenticated by the secure boot loader authenticator, the secure boot loader authenticator will transfer the CPU control to the secure boot loader. Furthermore, the authentication of the secure boot loader usually takes a short time due to the small size of the secure boot loader. According to the conventional method, the secure boot loader comprises normal booting functions of the computer system, and is further used to authenticate the main image of the computer system in step 103. Generally speaking, the main image is defined to contain all software components that can be executed on the computer system. After the main image is authenticated by the secure-boot loader, the CPU control is transferred to the main image to execute the main image (step 104). Normally, the main image comprises an operating system of the computer system and the associated embedded software applications. Furthermore, the authentication of the main image is usually performed at a time and thus may take a long time to complete the authentication, especially since the advances of computer technology require a high demand of the large-size main image.

Therefore, the problem of the conventional secure boot comes with the authentication of the main image by the secure boot loader. The larger the total system software size (i.e. the main image size), the longer the time to complete the booting process, which is from the moment the computer system gets powered on to the point the computer system can normally perform its designed functions.

### SUMMARY OF THE INVENTION

Therefore, the present invention discloses a computer system and a method thereof to improve the authentication of software components of the computer system.

According to an embodiment of the present invention, a computer system comprises a storage device and a processor. The storage device stores a loader authenticator, a boot loader, an operating system, and at least a software application. The processor is coupled to the storage device, for executing the loader authenticator to authenticate the boot loader; and when the boot loader passes the authentication, executing the boot loader to authenticate the operating system only, wherein the at least one software application is not authenticated by the boot loader.

According to another embodiment of the present invention, a method of operating a computer system including a storage device for storing a loader authenticator, a boot loader, an operating system, and at least a software application, comprises the following steps: executing the loader authenticator to authenticate the boot loader; and when the boot loader passes the authentication, executing the boot loader to authenticate the operating system, wherein the at least one software application stored in the storage device is not authenticated by the boot loader.

According to the present invention, not all of the software applications are authenticated before the operating system is executed, thus the booting time is greatly shortened. Additionally, in one embodiment of the present invention, a software application undergoes an authentication when it is requested to be executed. Moreover, in another embodiment of the present invention, a software application which has passed the authentication already is executed by the processor directly, thereby boosting the performance of the computer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a conventional method of secure boot performed upon a computer system.

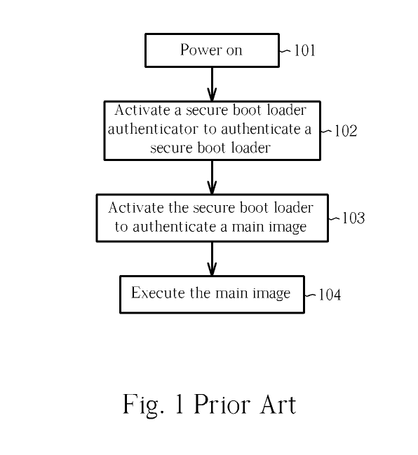

FIG. 2 is a diagram of a computer system according to an embodiment of the present invention.

FIG. 3 is a flowchart illustrating a method for operating the computer system shown in FIG. 2.

FIG. 4 is a flowchart illustrating a method of executing a secure execution determinator of an operating system according to an embodiment of the present invention.

### DETAILED DESCRIPTION

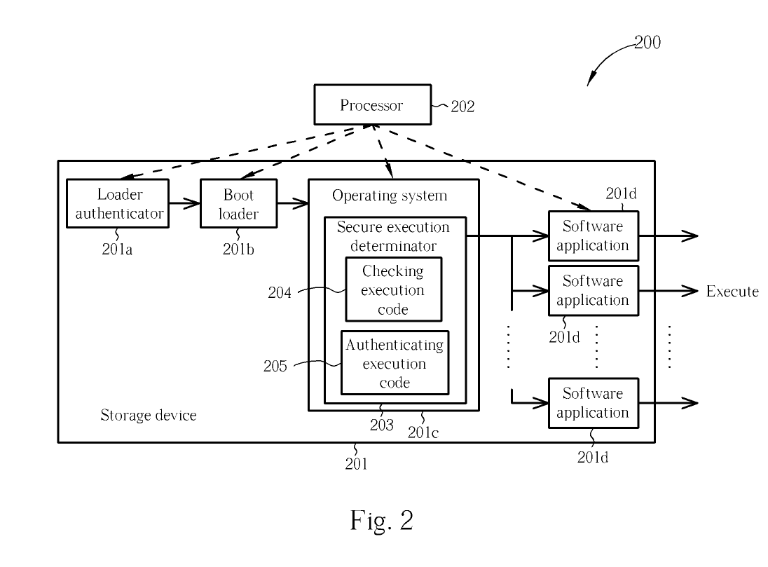

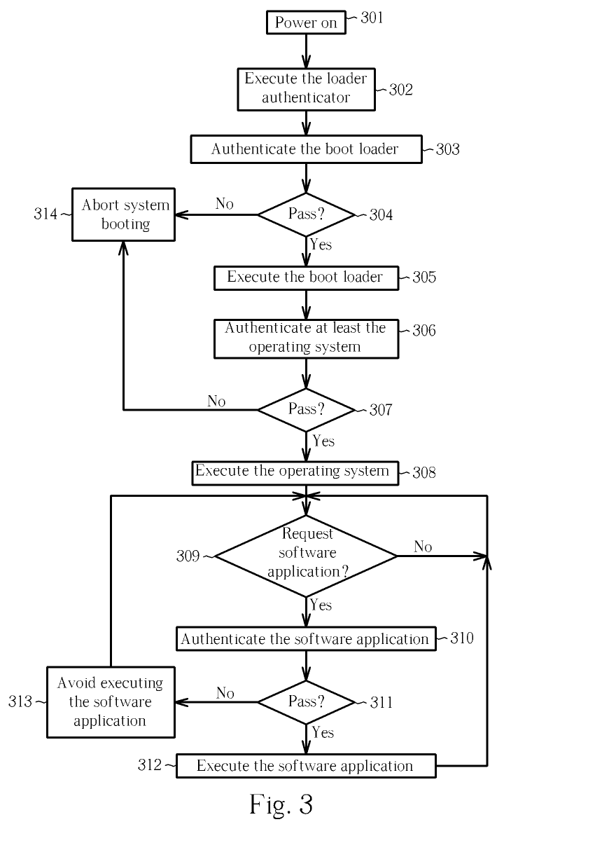

Please refer to FIG. 2, which is a diagram illustrating a computer system 200 according to an embodiment of the present invention. The computer system 200 comprises a storage device 201 and a processor 202. The storage device 201 is utilized to store a loader authenticator 201a, a boot loader 201b, an operating system 201c, and at least a software application 201d. The processor 202 is coupled to the storage device 201 for accessing the program execution codes stored therein. Please refer to FIG. 2 in conjunction with FIG. 3. FIG. 3 is a flowchart illustrating a method for operating the computer system 200 shown in FIG. 2. The method comprises the following steps:

Step 301: Power on;

Step 302: Execute the loader authenticator 201a;

Step 303: Authenticate the boot loader 201b;

Step 304: Check whether the boot loader 201b passes the authentication. If yes, go to step 305; otherwise, go to step 314;

Step 305: Execute the authenticated boot loader 201b;

Step 306: Authenticate at least the operating system 201c, wherein at least one software application 201d stored in the storage device 201 is not authenticated by the boot loader 201b;

Step 307: Check whether the operating system 201c passes the authentication. If yes, go to step 308; otherwise, go to step 314;

Step 308: Execute the authenticated operating system 201c;

Step 309: Check whether a software application 201d is requested to be executed. If yes, go to step 310; otherwise, execute step 309 again;

Step 310: Authenticate the requested software application 201d.

Step 311: Check whether the requested software application 201d passes the authentication. If yes, go to step 312; otherwise, go to step 313;

Step 312: Execute the requested software application 201d, and then go to step 309 for processing the next requested software application;

Step 313: Prevent the requested software application 201d from being executed, and then go to step 309 for processing the next requested software application;

Step 314: Abort the booting of the computer system 200.

Please note that, in order to describe the present invention clearly, the embodiment of the computer system 200 and the corresponding method can be applied to a secure-boot authentication of a set-top box (STB); however, this is not meant to be a limitation of the present invention. In other words, loader authenticator 201a can be a secure-boot loader authenticator, the boot loader 201b can be a secure-boot loader, and the operating system 201c can be a secure execution enabled OS of the set-top-box, according to one embodiment of the present invention. When the computer system 200 is powered on (step 301), the loader authenticator 201a is activated and executed by the processor 202 firstly (step 302), and then the processor 202 executes the loader authenticator 201a to authenticate the boot loader 201b of the computer system 200 (step 303), wherein the boot loader 201b is responsible for normal booting functions of the computer system 200. Furthermore, when the boot loader 201b passes the authentication (step 304), the loader authenticator 201a will pass the CPU control to the boot loader 201 b to represent that the boot loader 201b has been authenticated. Accordingly, the processor 202 will take control to the boot loader 201b according to the CPU control. Therefore, the boot loader 201b is activated (step 305).

Then, the processor 202 executes the boot loader 201b to authenticate the operating system 201c of the computer system 200 only (step 306). This is because the time that is required for authenticating the operating system 201c is significantly smaller than the total time required for authenticating all software components including the software applications 201d and the operating system 201c. Please note that, meanwhile, the boot loader 201b of the present invention is not limited to just authenticating the operating system 201c, but the boot loader 201b, in other embodiments, can also authenticate some (but not all) of the software applications 201d stored in the computer system 200. Therefore, if compared to the conventional secure-booting process, the booting time of the present invention must be shorter than the conventional booting time if both the computer systems have the same number of software applications 201d and identical computing power. For simplicity, only the operating system 201c is authenticated by the boot loader 201b as shown in FIG. 2. After the operating system 201c passes the authentication (step 307), the CPU control will be passed to the operating system 201c, and the processor 202 starts executing the operating system 201c in order to enter an operation stage of the computer system 200.

It should be noted that some or all of the software applications 201d may not be authenticated by the computer system 200 after the computer system 200 enters the operation stage. In the present invention, the software applications 201d that have not been authenticated are not allowed to be executed by the processor 202. In order to maintain the same security level as the prior art, executable software applications 201d are still required to be authenticated when requested, but the authentications of these requested software applications 201d are not performed all at once. Therefore, in this embodiment, the operating system 201c has a secure execution determinator 203 executed by the processor 202 for determining whether a specific software application 201d can be executed when the specific software application 201d is requested for execution. For example, when a software application 201d is requested to be executed (step 309), the processor 202 executes the secure execution determinator 203 to authenticate the requested software application 201d. If the requested software application 201d passes the authentication, the requested software application 201d is allowed to be executed by the processor 202 (step 312); otherwise, the processor 202 avoids executing this requested software application 201d (step 313).

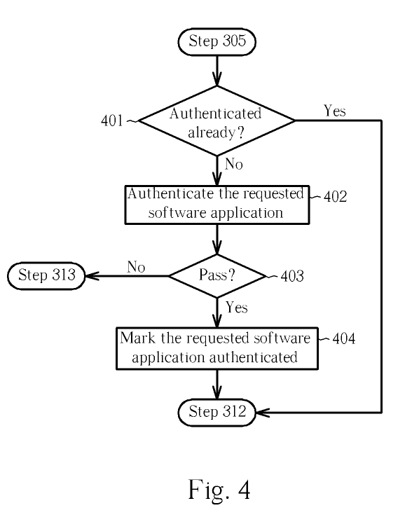

In the above embodiment, the authentication is applied to a software application 201d each time it is requested, which might degrade the performance of the computer system 200 if the software application that has passed a previous authentication is authenticated again. To improve the performance of the computer system 200, the prevent invention further provides an improved authentication procedure to replace the steps 310 and 311. As shown in FIG. 2, the secure execution determinator 203 comprises a checking execution code 204 and an authenticating execution code 205. Please refer to FIG. 4. FIG. 4 is a flowchart illustrating a method of executing the secure execution determinator 203 of the operating system 201c according to an embodiment of the present invention. The method comprises the following steps:

Step 401: Check whether the requested software application 201d has been authenticated; if yes, go to step 312; if no, go to step 402;

Step 402: Authenticate the requested software application 201d;

Step 403: Check whether the requested software application 201d passes the authentication. If yes, go to step 403; if the authentication fails, go to step 404;

Step 403: Mark the requested software application 201d authenticated, and then go to step 312.

Accordingly, in step 401 the processor 202 will process the checking execution code 204 of the secure execution determinator 203 to check whether the requested software application 201d has been authenticated; if yes, then the processor 202 continues to step 312 to execute the requested software application 201d directly since it is guaranteed that executing the requested software application 201d does no harm to the computer system 200; if no, then the processor 202 executes the authenticating execution code 205 of the secure execution determinator 203 to perform the first-time authentication to the requested software application 201d (step 402). If the requested software application 201d passes the authentication (step 403), the secure execution determinator 203 will set a specific flag to mark the requested software application 201d authenticated (step 404). Then, the processor 202 continues to execute step 312 to run the requested software application 201d. Accordingly, through the specific flag, the secure execution determinator 203 can prevent the same authentication being repeated every time the authenticated software application 201d gets invoked. If the requested software application 201d fails the authentication, the processor 202 avoids executing the unsafe software application 201d (step 313).

In contrast to the conventional secure boot mechanism, the present invention does not authenticate all of the software applications before the operating system is executed, shortening the booting time greatly. Additionally, in one embodiment of the present invention, a software application undergoes an authentication when it is requested to be executed. Moreover, in another embodiment, a software application which has passed the authentication previously is executed by the processor directly, thereby boosting the performance of the computer system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system, comprising:
a storage device, storing a loader authenticator, a boot loader, an operating system, and at least a software application; and
a processor, coupled to the storage device, for executing the loader authenticator to authenticate the boot loader;
wherein when the boot loader passes the authentication, the boot loader is executed to authenticate at least the operating system, and the at least one software application is not authenticated by the boot loader.

2. The computer system of claim 1, wherein the boot loader executed by the processor authenticates the operating system only, and when the operating system passes the authentication, the processor further executes the operating system.

3. The computer system of claim 2, wherein the operating system comprises a secure execution determinator executed by the processor for determining whether a specific software application can be executed by the processor when the specific software application is requested for execution.

4. The computer system of claim 3, wherein the secure execution determinator comprises:
a checking execution code, executed by the processor for checking whether the specific software application has been authenticated; and
an authenticating execution code, executed by the processor for authenticating the specific software application if the checking execution code identifies that the specific software application is not authenticated yet.

5. The computer system of claim 4, wherein if the checking execution code executed by the processor identifies that the specific software application has been authenticated, the processor then executes the authenticated specific software application; if the specific software application passes the authentication performed by the authenticating execution code executed by the processor, the authenticating execution code executed by the processor marks the specific software application authenticated and then the processor executes the specific software application; and if the specific software application fails to pass the authentication performed by the authenticating execution code executed by the processor, the processor is prevented from executing the specific software application.

6. The computer system of claim 1, being a set-top box (STB).

7. The computer system of claim 6, wherein the STB is a DTV STB.

8. A method of operating a computer system, the computer system comprising a storage device for storing a loader authenticator, a boot loader, an operating system, and at least a software application; the method comprising:
executing the loader authenticator to authenticate the boot loader; and
when the boot loader passes the authentication, executing the boot loader to authenticate the operating system, wherein the at least one software application stored in the storage device is not authenticated by the boot loader.

9. The method of claim 8, wherein the boot loader authenticates the operating system only, and when the operating system passes the authentication, executing the operating system.

10. The method of claim 9, further comprising: executing the operating system to determine whether a specific software application can be executed when the specific software application is requested for execution.

11. The method of claim 10, wherein the step of executing the operating system to determine whether the specific software application can be executed comprises:
checking whether the specific software application has been authenticated; and
authenticating the specific software application if the specific software application is not authenticated yet.

12. The method of claim 11, further comprising:
if the specific software application has been authenticated, executing the authenticated specific software application;
if the specific software application passes the authentication, marking the specific software application authenticated and then executing the specific software application; and
if the specific software application fails to pass the authentication, preventing the specific software application from executed.

13. The method of claim 8, being utilized in a set-top box (STB).

14. The method of claim 13, wherein the STB is a DTV STB.
